(19) United States
(12) Patent Application Publication
(10) Pub. No.: US 2012/0133796 A1
(43) Pub. Date: May 31, 2012

(54) IMAGE PROCESSING SYSTEM AND METHOD THEREOF, COMPUTER READABLE STORAGE MEDIUM

(76) Inventor: CHUNG-CHIU WU, TAIPEI CITY (TW)

(21) Appl. No.: 13/304,600

(22) Filed: Nov. 25, 2011

(30) Foreign Application Priority Data
Nov. 26, 2010 (TW) 099141126

(51) Int. Cl. H04N 5/76

(52) U.S. Cl. 348/231.99; 348/E05.031

(57) ABSTRACT

The present invention discloses an image processing system, a method thereof and a tangibly embodied computer readable storage medium. The image processing method is applied in the image processing system and comprises the steps of: storing a display content; capturing at least one image by using an image capturing unit; analyzing the appearance of an object in the at least one image to get a contour curve via a processing unit; embedding the display content into the contour curve, or changing the quantity, color, size, shape or angle of the object; and displaying the image comprising the object by a display unit after the processing unit processes the image.

### CROSS-REFERENCE TO RELATED APPLICATION

This application claims the benefit of Taiwan Patent Application No. 099141126, filed on Nov. 26, 2010, in the Taiwan Intellectual Property Office of the Republic of China, the disclosure of which is incorporated herein in its entirety by reference.

### BACKGROUND OF THE INVENTION

1. Field of the Invention

The present invention relates to an image processing system, a method thereof, and a tangibly embodied computer readable storage medium, in particular to the image processing system and method that analyzes the appearance of an object in an image for changing a figure of the object, or embeds display content into the contour of the object.

2. Description of the Related Art

Conventional monotonous text no longer can attract people's attention anymore, and multimedia images with plentiful and variable contents can substitute the traditional text. Thus, it has been a major issue for related manufacturers of how to process the images to attract people's attention.

In the process of pursuing innovations of science and technology, designers have to adjust various parameters one by one to complete an image work while processing the images in accordance with conventional image processing technologies. However, the cumbersome configuration has caused tremendous inconvenience to the designers and low operation efficiency.

Therefore, the conventional image processing technologies can no longer meet the designers' requirements, and an automated processing technology is required to improve the designers' flexibility and convenience on the image creations. Based on the aforementioned reasons and considerations, the inventor(s) of the present invention pondered and designed an image processing system, a method thereof and a tangibly embodied computer readable storage medium, in hope of overcoming the drawbacks of the prior art, and improving the utility of the invention in the related industry.

### SUMMARY OF THE INVENTION

In view of the problems of the prior art, it is a primary objective of the present invention to, provide an image processing system, a method thereof, and a tangibly embodied computer readable storage medium. Wherein, by analyzing the appearance of an object in an image, a contour curve is obtained. A processing unit embeds display content into inside of the contour curve, or changes the quantity, color, size, shape, position, or angle of the object for enhancing the richness and fun of the images.

To achieve the foregoing objective, the present invention provides an image processing system, comprising a storage unit, an image capturing unit, a display unit and a processing unit. Wherein, the processing unit is coupled to the storage unit, the image capturing unit, and the display unit. The storage unit is provided for storing display content. The image capturing unit is provided for capturing at least one image. The processing unit is provided for analyzing an appearance of an object in the at least one image to obtain a contour curve, and embedding the display content into inside or outside of the contour, or changing the quantity, color, size, shape, position, or angle of the object to control the display unit to display the processed image containing the object.

Wherein, the image processing system further comprises a characteristic capturing unit coupled to the processing unit and provided for capturing a plurality of characteristics of the appearance of the object, and the processing unit analyzes the object according to a geometric relation between the plurality of characteristics.

Wherein, the plurality of characteristics includes a geometric shape, skeleton information, a texture structure, a high frequency component proportion, or any combination of the above.

Wherein, the display content includes a text, a figure, a chart, a multimedia datum, a material of the object, or any combination of the above.

To achieve the foregoing objective, the present invention further provides an image processing method. The image processing method is applicable in an image processing system, and the image processing system comprises a storage unit, an image capturing unit, a display unit, and a processing unit. The image processing method comprises the steps of: using a storage unit to store display content; using an image capturing unit to capture at least one image; using a processing unit to analyze an appearance of an object in the at least one image to obtain a contour curve; embedding the display content into inside or outside of the contour curve by the processing unit, or changing the quantity, color, size, shape, or angle of the object; and using a display unit to display an image containing the object after being processed by the processing unit.

Wherein, the image processing method further comprises the steps of: using a characteristic capturing unit to capture a plurality of characteristics of the appearance of the object; and using the processing unit to analyze the object according to a geometric relation between the plurality of characteristics.

Wherein, the plurality of characteristics includes a geometric shape, skeleton information, a texture structure, a high frequency component proportion, or any combination of the above.

Wherein, the display content includes a text, a figure, a chart, a multimedia datum, a material of the object, or any combination of the above.

To achieve the foregoing objective, the present invention further provides a tangibly embodied computer readable storage medium comprising a program code, after a processor loads and executes the program code, the method as described above can be achieved.

As described above, the image processing system and method, the tangibly embodied computer readable storage medium of the present invention have the advantages of being capable of using the processing unit to analyze the appearance of the object to obtain the contour curve of the object, and embedding the display content into the contour curve or changing the shape of the object to enhance the richness and fun of the images.

### BRIEF DESCRIPTION OF THE DRAWINGS

FIG. 1 is a block diagram of an image processing system of the present invention;

FIG. 2 is a schematic view of an image processing system in accordance with a first preferred embodiment of the present invention;

FIG. 3 is a schematic view of a display screen of an image processing system in accordance with the first preferred embodiment of the present invention;

FIG. 4 is a schematic view of another display screen of an image processing system in accordance with the first preferred embodiment of the present invention;

FIG. 5 is a schematic view of an image processing system in accordance with the second preferred embodiment of the present invention;

FIGS. 6A to 6C are another schematic views of an image processing system in accordance with the second preferred embodiment of the present invention;

FIG. 7 is a schematic view of an image processing system in accordance with a third preferred embodiment of the present invention;

FIG. 8 is a flow chart of an image processing method of the present invention; and

FIG. 9 is another flow chart of an image processing method of the present invention.

### DETAILED DESCRIPTION OF THE PREFERRED EMBODIMENTS

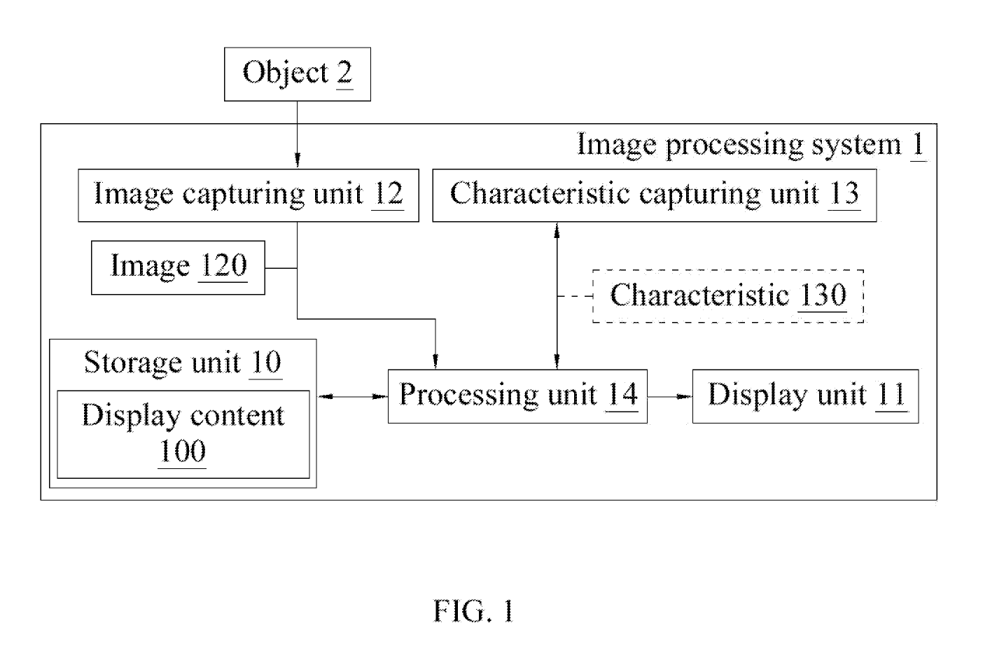

With reference to FIG. 1 for a block diagram of an image processing system of the present invention, the image processing system 1 comprises a storage unit 10, a display unit 11, an image capturing unit 12, a characteristic capturing unit 13, and a processing unit 14. The processing unit 14 is electrically coupled to the storage unit 10, the display unit 11, the image capturing unit 12, and the characteristic capturing unit 13. Wherein, the characteristic capturing unit 13 can be a standalone computing chip; the processing unit 14 can be a standalone central processor or micro-processor; the display unit 11 can be any display device such as a liquid crystal display (LCD) screen, a projector, an organic light emitting display (OLED) display or an e-paper, but the invention is not limited to such arrangements only.

In addition, the image capturing unit 12 can be any photographic devices, such as a camera or a camcorder for capturing an image 120, wherein the image 120 includes an object 2 (including but not limited to the whole or a part of appearance of a man or an animal). The storage unit 10 can be any storage media including a built-in memory, an external memory or memory card, floppy disk, or optical disk for storing display content 100. The display content 100 includes a text, a figure, a chart, a multimedia datum, a material of the object 2, or any combination of the above, such as text data, image/media data, and, animation data, wherein the material of the object can be a texture or color thereof.

The processing unit 14 is provided for controlling the characteristic capturing unit 13 to analyze the image 120 to obtain a plurality of characteristics 130 of the appearance of the object 2. Wherein, the plurality of characteristics 130 includes but not limited to a geometric shape, skeleton information, a texture structure, a high frequency component proportion or any combination of the above. The processing unit 14 analyzes the appearance of the object 2 according to a geometric relation of the plurality of characteristics 130 to obtain a contour curve of the object 2. The processing unit 14 further embeds the display content 100 into the inside or outside of the contour curve of the object 2, or changes the figure of the object 2, such as changing the quantity, color, size, shape, position, or angle of the object 2. Therefore, the image processing system 1 of the present invention can use the processing unit 14 to analyze the appearance of the object 2 in the image 120 to embed the display content 100 into the inside or outside of the contour curve of the object 2, or changes the figure of the object 2. Thus, the designer can use the image processing system 1 of the present invention to add changes to the design, enrich the content of the image, and improve the fun of the image.

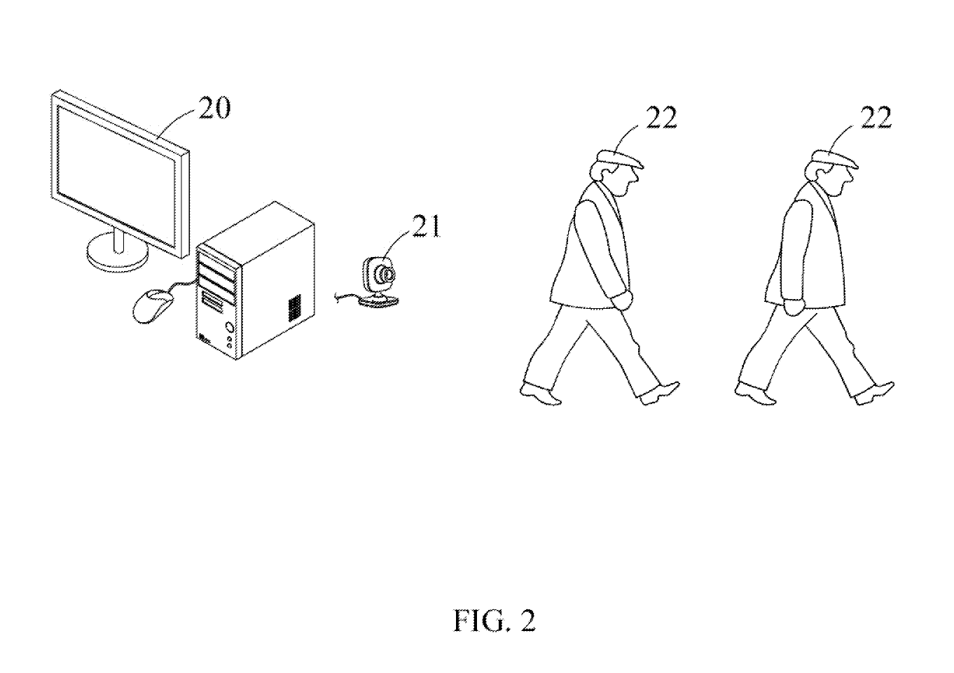

With reference to FIG. 2 for a schematic view of an image processing system in accordance with the first preferred embodiment of the present invention, the image processing system is a computer 20, wherein the image capturing unit is a camera 21, and the computer 20 is electrically coupled to a camera 21. The camera 21 is used for capturing an image of a man 22. In some embodiments, the camera 21 is equipped with a sensor (not shown in the figure, e.g. thermal sensor or an infrared sensor etc.) electrically coupled to the computer 20. If the sensor detects that the man 22 passes through a sensing range, the sensor will issue a signal to the computer 20 to control the camera 21 to take a picture and capture an image. The computer 20 will perform a pre-processing of the image, including a thinning processing, a sharpening processing, a smoothing processing, a noise removal processing, a background removal processing, a character removal processing, or a change of image resolution/size etc. Then, the computer 20 further analyzes the pre-processed image to capture a plurality of characteristics of the appearance of the man 22. In some preferred embodiments, the analysis method includes but not limited to use each image in a skeleton image to obtain a characteristic vector of each characteristic point of the man 22. For a single image, the computer 20 can use a topology analysis to analyze a geometric relation between the characteristic points. For a video section comprised of a plurality of images, the computer 20 can analyze the displacement, deformation, or moving frequency of each characteristic point based on a characteristic vector of each characteristic point to obtain a contour curve of the man 22 and recognize different movement status of the man 22 to produce a recognition result. The computer 20 embeds the display content in the storage unit into the contour curve of the man 22, changes the figure of the man 22 in the image, or performs a combination of the above.

It is noteworthy to point out that although the concept of the present invention is illustrated by the example of using a skeleton image to analyze the characteristics. The persons of ordinary skill in the art should be able to understand and extend the different methods for analyzing the image to capture the characteristics. These methods include but not limited to the method of analyzing the contour or texture of the object in the image according to the configuration of the users.

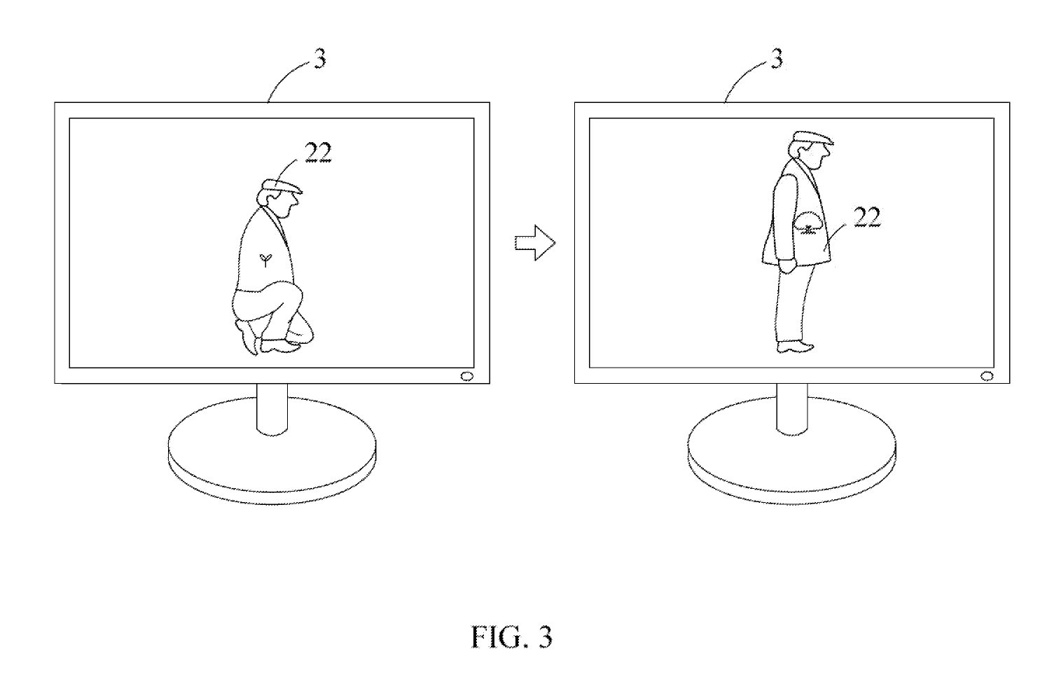

With reference to FIGS. 2 and 3 for schematic views of display screens of an image processing system in accordance with the first preferred embodiment of the present invention, the computer 20 embeds the display content into the contour curve of the man 22, wherein the display content includes texts, figures, charts, multimedia, materials of an object or any combination of the above. In addition, the computer 20 further provides different display contents to be embedded into the contour curve of the man 22 based on as least one recognition result, including but not limited to leaning forward, standing up, squatting, walking, looking back, jumping, retreating, etc. As displayed in the display screen 3, a picture of a small tree is embedded at a squatting posture, and an animation of a small tree growing to be a big tree is embedded at a standing up posture. The processing unit can embed different display content according to different movement postures into contour curves to give more fun and attract people's attention. If this effect can be used properly in the field of advertising, a good promotion effect can be achieved.

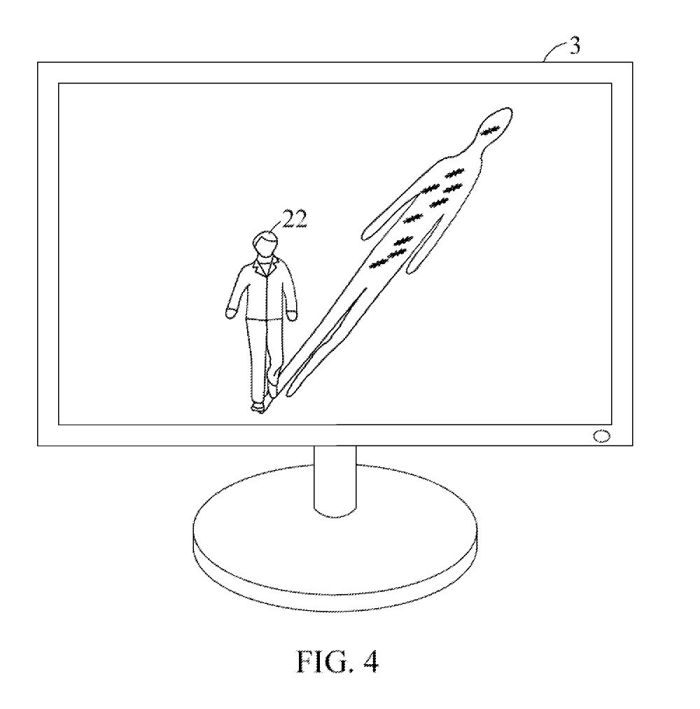

With reference to FIGS. 2 and 4 for schematic views of an another display screen of an image processing system in accordance with the first preferred embodiment of the present invention, FIG. 4 shows that the computer 20 changes the figure of the man 22 in the image and embeds the display content into a contour range of the man 22. For example, the change of the figure includes but not limited to a change in color, duplication, symmetric replacement, rotation, inversion, zoom in/out, superimposition, or deformation of the figure.

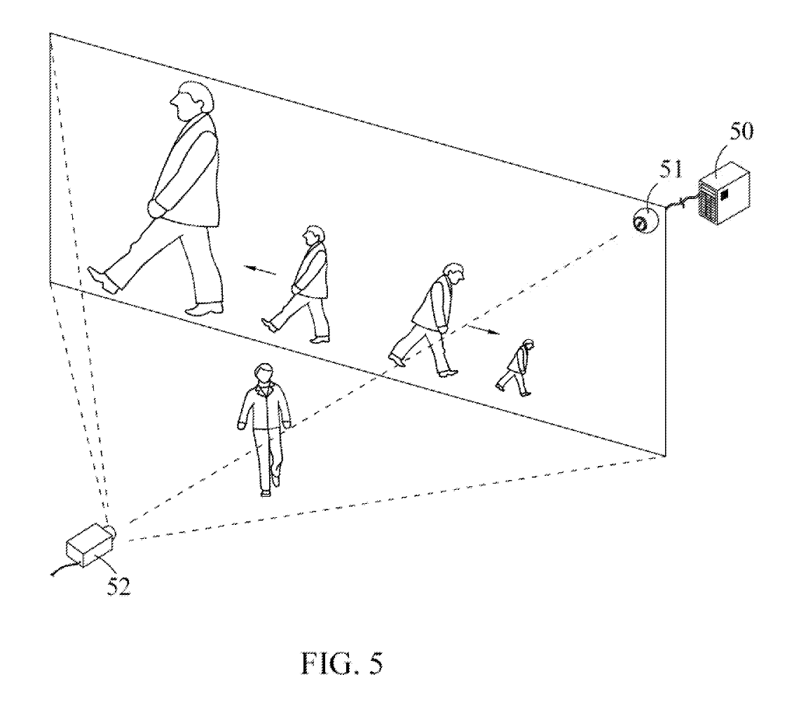

With reference to FIG. 5 for a schematic view of an image processing system in accordance with the second preferred embodiment of the present invention, the image processing system is a host system 50, and the image capturing unit is a pin-hole camera 51, and the display unit is a projector 52. In this preferred embodiment, the imaging processing system is used for a scene of installation art. If the sensor detects that there is a man 22 entering this scene, the host system 50 will trigger the pin-hole camera 51 to capture an image. It is noteworthy to point out that the host system 50 is not only capable of analyzing single images, but also capable of analyzing a video section, since the video section is composed of a plurality of images. Therefore, the host system 50 may analyze the appearance of the object in each image to obtain the contour curve of the object and recognize the movement of the object to generate a recognition result. After the host system 50 processes the image, the host system 50 controls the projector 52 to project a video section. In the figure, this video contains two duplicated images of the man 22, wherein one image shows the man 22 walking forward and becoming increasingly larger, and the other image shows the man 22 walking towards the back and becoming increasingly smaller, so that when the man 22 enters this art device, the man 22 can see the image including himself, so as to enhance the fun visually.

In addition, although the camera 21 can capture an image fixedly, in some preferred embodiments, the camera 21 can move and/or rotate to capture a plurality of images continuously to form a video section, and the present invention does not limit the position of image capturing unit and the way of taking picture. In addition, the processing unit can analyze, the overall appearance of the object in the image, and also analyzes a partial appearance of the object in the image, such as an arm, a body, a limb, or a head, so that a contour curve of a partial appearance of the object can be obtained, and the present invention does not limit the analyzing range of the processing unit, depending on the user configuration.

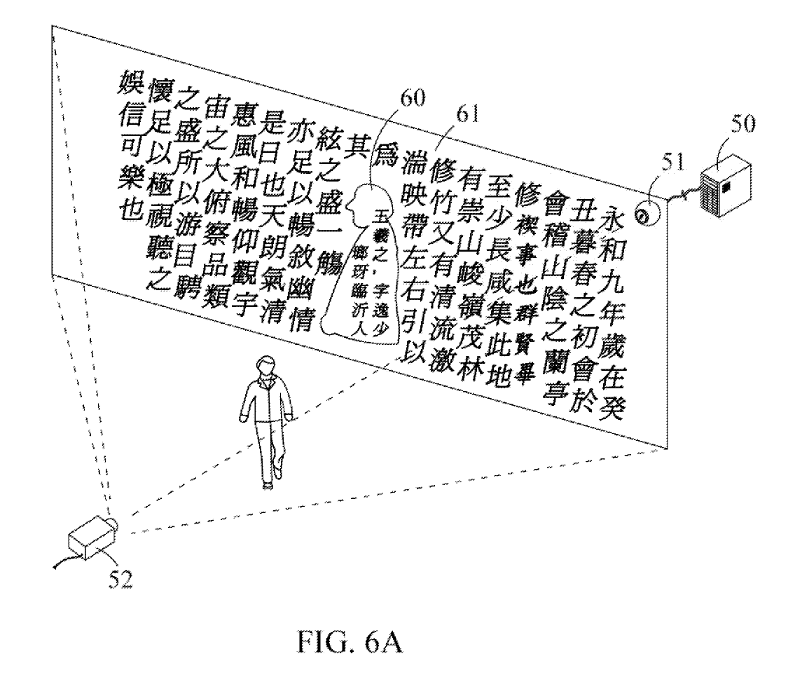

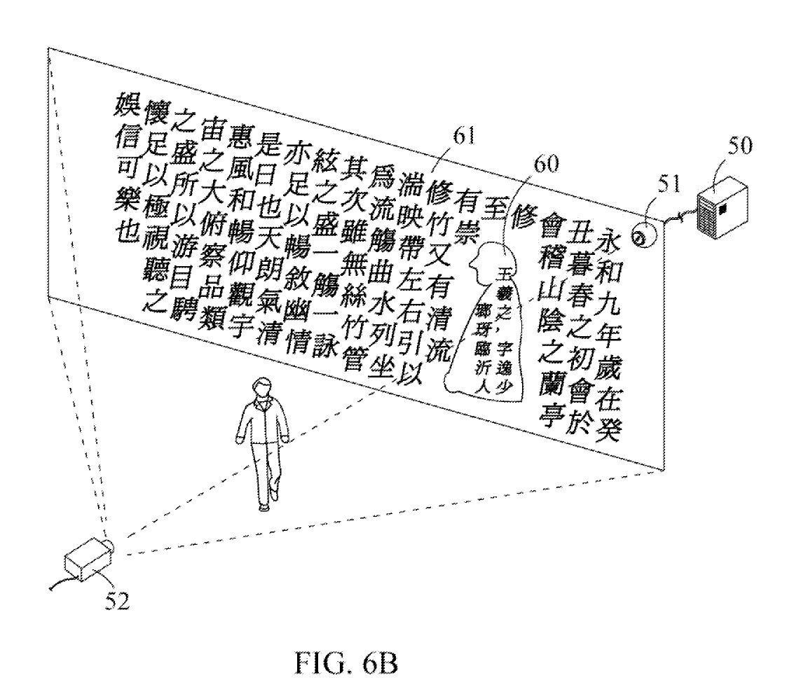

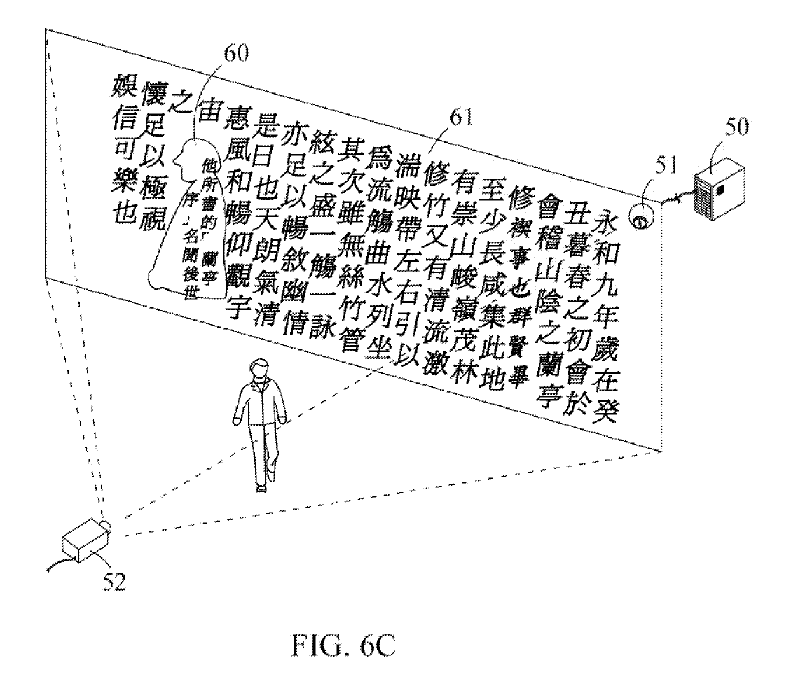

With reference FIGS. 6A to 6C for another schematic views of an image processing system of the second preferred embodiment of the present invention, the structure of this embodiment is substantially the same as the foregoing second embodiment, except that the camera 21 comes with a rotatable lens for capturing a video section comprising a plurality of images from different angles. In this preferred embodiment, the computer 20 analyzes the movement, deformation, or moving frequency of each characteristic point in the characteristic analyzing image according to an upper-body characteristic of the man 22, so as to obtain the upper-body contour curve of the man 22. The computer 20 embeds a paragraph of texts 60 (including but not limited to the bibliography of Wang Xizhi) into the upper body contour of this man 22, and controls a projector 52 to project the processed video. In FIG. 6B, when the upper body of the man 22 in the video moves, the text 60 in the contour curve also moves. In other words, the upper body of the man 22 and the embedded text 60 are merged integrally in the video, so that the embedded text 60 can be moved or rotated with a change of figure.

In another preferred embodiment as shown in FIG. 6C, if the upper body of the man 22 in the video moves, different portions of this paragraph of text 60 can be displayed. In other words, this paragraph of text 60 is fixed, and can be moved with the upper body of the man 22 in the video, so as to correspondingly display the text 60 in the contour curve. The designer can use the computer 20 to embed a calligraphic work 61 into outside of the contour curve of the upper body of the man 22, or even change the contour curve of the upper body of this man 22 in the image (not shown in the figure), and controls the projector 52 to project the processed video containing this man 22. Therefore, the design can repeatedly process the image as needed to easily achieve different visual effects.

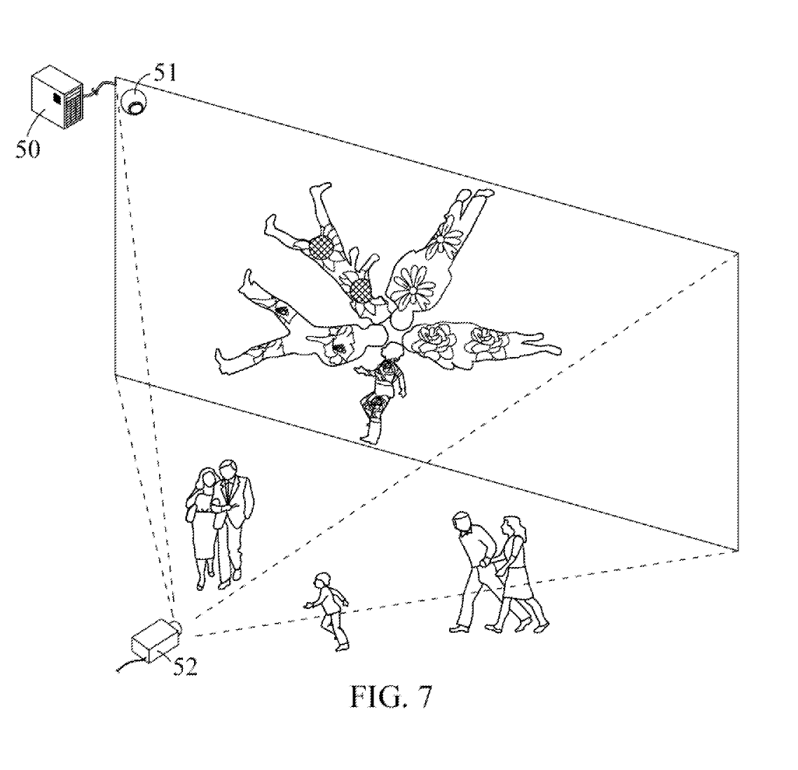

With reference to FIG. 7 for a schematic view of an image processing system in accordance with the third preferred embodiment of the present invention, the structure of this embodiment is substantially as same as the second preferred embodiment, except that this preferred embodiment is disposed in an exhibition such as a Flora Expo. After the pin-hole camera 51 captures an image of the exhibition site, the host system 50 analyzes the appearance of all people in the image to obtain a corresponding contour curve of each person, and embeds display content containing various flower patterns into the contour curve of each person, and arranges the group of people into a circular shape, or even changes the figure of the image embedded with flower pattern. The changes include but not limited to a deformation, rotation, zoom-in or zoom out, etc., so that combining the subject of the Flora Expo makes people at the exhibition site become the element of the installation art, so as to enhance the visual and interactive effects of the exhibition, and improve the fun and artistry of the image.

In addition, the aforementioned computer or host system can be any other processor or electronic device, and the present invention is not limited to any particular type of processing units. The image processed by the image processing system of the present invention may have unlimited changes depending on the user's configuration.

Although the concept of the image processing method of the present invention has been described in the section of describing the image processing system, yet a flow chart is provided for illustrating the invention clearly as follows.

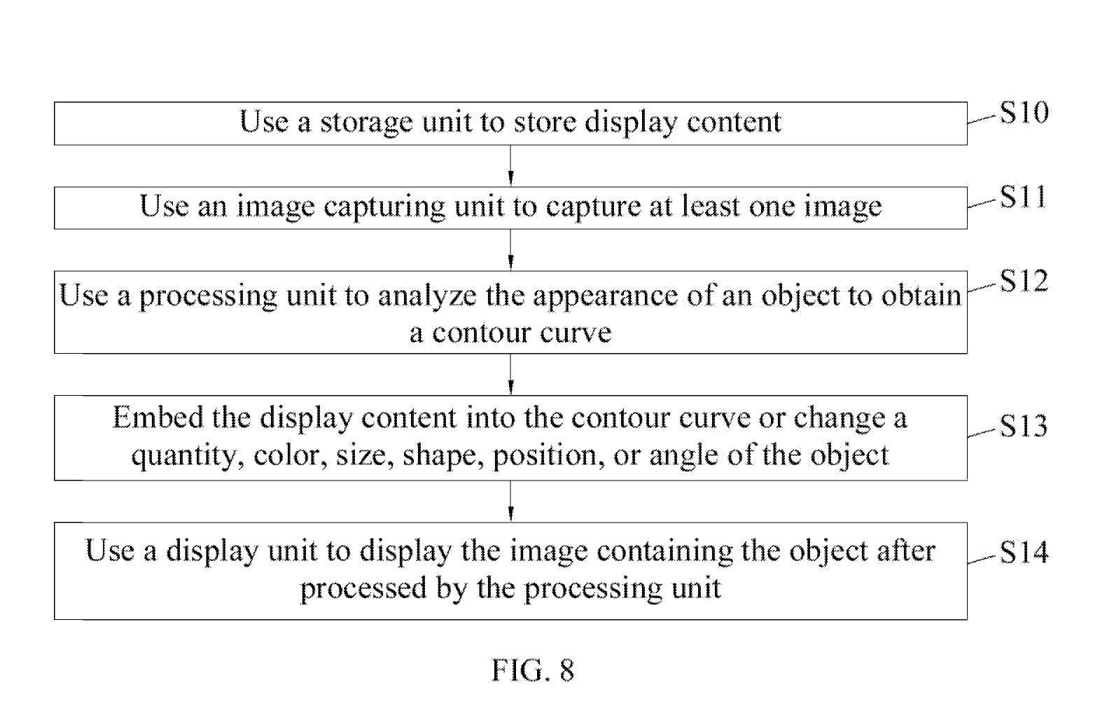

With reference to FIG. 8 for a flow chart of an image processing method in accordance with the present invention, the image processing method is applicable in an image processing system comprising a storage unit, a display unit, an image capturing unit, a characteristic capturing unit and, a processing unit. The image processing method comprising the steps of:

(S10) using a storage unit to store display content;

(S11) using an image capturing unit to capture at least one image;

(S12) using a processing unit to analyze the appearance of an object in the image to obtain a contour curve;

(S13) using the processing unit to embed display content into the contour curve, or change the quantity, color, size, shape or angle of the object; and

(S14) using a display unit to display an image containing the object after being processed by the processing unit.

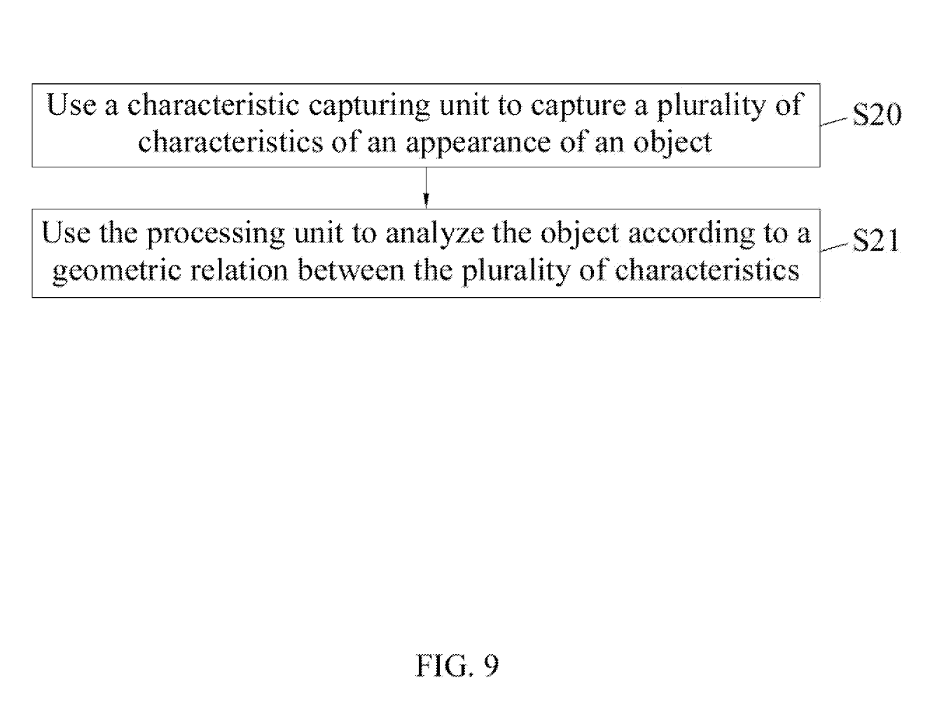

With reference to FIG. 9 for another flow chart of an image processing method in accordance with the present invention, the image processing method further comprises the steps of:

(S20) using a characteristic capturing unit to capture plurality of characteristics of the appearance of the object; and

(S21) using the processing unit to analyze the object according to a geometric relation between the plurality of characteristics.

Wherein, the step (S20) preferably takes place before the step (S12).

The implementation of each step has been described in the section of the image processing system, and this will not be repeated.

Each of the aforementioned units or elements can be achieved by hardware, software, or a combination thereof, and may further be equipped with necessary firmware devices. People of ordinarily skilled in the art should be able to understand that when any unit is implemented by software, the software can be stored in a medium such as CD, DVD, MD, floppy disk, flash drive, memory card, or any other storage device in which the program codes that can be read by an electronic device are stored. Additionally, the storage medium for the present invention can be used for storing an operating system or any other application programs selectively.

The present invention can be applied to an image processing system. In addition, a storage medium can be used for the implementation, and the storage medium can store a program code to complete the image processing method in accordance with the preferred embodiment. In addition, the present invention can be implemented by a computer program product. The computer program product stores the program code, such that after a processor reads and executes the program code, the method of the preferred embodiment can be achieved. The computer program product can be transmitted via network or any other method selectively.

It is noteworthy to point out that the preferred embodiments of the present invention are provided for illustrating the present invention, but not intended for limiting the scope of the invention, and numerous modifications and variations could be made thereto by those skilled in the art without departing from the scope and spirit of the invention set forth in the claims.

In summation of the description above, the image processing system and the method thereof, and the tangibly embodied computer readable storage medium of the present invention can overcome the drawbacks of the prior art and waive the cumbersome configuration for processing images, so as to analyze the appearance of the object to obtain the contour curve of the object, and use the processing unit to embed the display content into the contour curve, or change the figure of the object. The invention can enrich the work of the image, so that designers can use the image processing platform to process the images (including but not limited to the work of art creation, movie production, etc.) flexibly and conveniently. In addition, the invention provides rich image contents and improves the diversity of the images to add more fun to the images.

What is claimed is:

1. An image processing system, comprising:
a storage unit, for storing display content;
an image capturing unit, for capturing at least one image;
a processing unit, coupled to the storage unit and the image capturing unit, for analyzing an appearance of an object in the at least one image to obtain a contour curve, and the processing unit embedding the display content into inside or outside of the contour curve, or changing a quantity, color, size, shape, position, or angle of the object; and
a display unit, coupled to the processing unit, for displaying an image including the object after being processed through the processing unit.

2. The image processing system of claim 1, further comprising a characteristic capturing unit coupled to the processing unit and provided for capturing a plurality of characteristics of the appearance of the object, and the processing unit analyzing the object according to a geometric relation between the plurality of characteristics.

3. The image processing system of claim 2, wherein the plurality of characteristics includes a geometric shape, skeleton information, a texture structure, a high frequency component proportion, or a combination thereof.

4. The image processing system of claim 1, wherein the display content includes a text, a figure, a chart, a multimedia datum, a material of the object, or a combination thereof.

5. An image processing method, comprising following steps of:
using a storage unit to store display content;
using an image capturing unit to capture at least one image;
using a processing unit to analyze an appearance of an object in the at least one image to obtain a contour curve;
embedding the display content into inside or outside of the contour curve by the processing unit, or changing a quantity, color, size, shape, or angle of the object; and
using a display unit to display an image including the object after being processed by the processing unit.

6. The image processing method of claim 5, further comprising following steps of:
using a characteristic capturing unit to capture a plurality of characteristics of the appearance of the object; and
using the processing unit to analyze the object according to a geometric relation between the plurality of characteristics.

7. The image processing method of claim 6, wherein the plurality of characteristics includes a geometric shape, skeleton information, a texture structure, a high frequency component proportion, or a combination thereof.

8. The image processing method of claim 5, wherein the display content includes a text, a figure, a chart, a multimedia datum, a material of the object, or a combination thereof.

9. A tangibly embodied computer readable medium comprising computer executable instructions, the instructions when executed by a computer causing the computer to perform an image processing method, the method comprising following steps of:
using a storage unit to store display content;
using an image capturing unit to capture at least one image;
using a processing unit to analyze an appearance of an object in the at least one image to obtain a contour curve;
embedding the display content into inside or outside of the contour curve by the processing unit, or changing a quantity, color, size, shape, or angle of the object; and
using a display unit to display an image including the object after being processed by the processing unit.

10. The tangibly embodied computer readable storage medium of claim 9, the method further comprising following steps of:
using a characteristic capturing unit to capture a plurality of characteristics of the appearance of the object; and
using the processing unit to analyze the object according to a geometric relation between the plurality of characteristics.

11. The tangibly embodied computer readable storage medium of claim 10, wherein the plurality of characteristics includes a geometric shape, skeleton information, a texture structure, a high frequency component proportion, or a combination thereof.

12. The tangibly embodied computer readable storage medium of claim 9, wherein the display content includes a text, a figure, a chart, a multimedia datum, a material of the object, or a combination thereof.
